(19) United States
(12) Patent Application Publication
(10) Pub. No.: US 2025/0367918 A1
(43) Pub. Date: Dec. 4, 2025

(54) POST-PROCESSING SYSTEM, IMAGE FORMING SYSTEM, AND POST-PROCESSING METHOD

(71) Applicant: Konica Minolta, Inc., Tokyo (JP)

(72) Inventor: Keita Kano, Tokyo (JP)

(73) Assignee: Konica Minolta, Inc., Tokyo (JP)

(21) Appl. No.: 19/222,543

(22) Filed: May 29, 2025

(30) Foreign Application Priority Data
Jun. 4, 2024 (JP) 2024-090547

(51) Int. Cl. B32B 41/00; B32B 38/00; G03G 15/00

(52) U.S. Cl. CPC B32B 41/00; B32B 38/0012; G03G 15/6582; G03G 15/6541

(57) ABSTRACT

A post-processing system includes: a laminating device that performs lamination on a recording medium; a post-processing device that is disposed on a downstream side of the laminating device in a conveyance direction of the recording medium and performs post-processing on the recording medium; and a control device that controls, in accordance with the lamination by the laminating device, the post-processing that is performed by the post-processing device on the recording medium.

### CROSS-REFERENCE TO RELATED APPLICATIONS

The entire disclosure of Japanese Patent Application No. 2024-090547, filed on Jun. 4, 2024 is incorporated herein by reference in its entirety.

### BACKGROUND OF THE INVENTION

### Technical Field

The present invention relates to a post-processing system, an image forming system, and a post-processing method.

### Description of Related Art

A post-processing device is an apparatus for performing post-processing such as folding and binding on a recording medium on which an image has been formed in an image forming apparatus. As a technology related to such a post-processing device, there is a technology disclosed in Japanese Unexamined Patent Publication No. 2023-96797. In this Japanese Unexamined Patent Publication No. 2023-96797, regarding post-processing on a laminated recording medium, it is disclosed that “a part where laminate films are bonded to each other is formed on the outside of the sheet edge after bonding, and a sheet processing apparatus performs post-processing such as punching or binding using this part as a post-processing margin”.

### SUMMARY OF THE INVENTION

Incidentally, a post-processing device has an upper limit value of the number of recording media that can be processed at once, according to the type of post-processing, regardless of whether the recording media have been laminated. However, a laminated recording medium has a thickness corresponding to a laminate film superposed on the recording medium. Therefore, a post-processing system which performs control by applying an upper limit value set for recording media not subjected to lamination to recording media subjected to lamination as it is generates processing failure at the time of post-processing and further causes mechanical malfunction of a post-processing device thereof.

An object of the present invention is to provide a post-processing system, an image forming system, and a post-processing method capable of preventing processing failure at the time of post-processing and mechanical malfunction of a post-processing device.

To achieve at least one of the abovementioned objects, according to an aspect of the present invention, a post-processing system reflecting one aspect of the present invention includes:
a laminating device that performs lamination on a recording medium;
a post-processing device that is disposed on a downstream side of the laminating device in a conveyance direction of the recording medium and performs post-processing on the recording medium; and
a control device that controls, in accordance with the lamination by the laminating device, the post-processing that is performed by the post-processing device on the recording medium.

According to an aspect of the present invention, an image forming system reflecting one aspect of the present invention includes:
the post-processing system; and
an image forming apparatus that is disposed on an upstream side of the laminating device in the conveyance direction of the recording medium and forms an image on the recording medium.

According to an aspect of the present invention, a post-processing method reflecting one aspect of the present invention is performed by a post-processing system including: a laminating device that performs lamination on a recording medium; and a post-processing device that is disposed on a downstream side of the laminating device in a conveyance direction of the recording medium and performs post-processing on the recording medium, and includes:
with a control device, controlling, in accordance with the lamination by the laminating device, the post-processing that is performed by the post-processing device on the recording medium.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic diagram illustrating a configuration of an image forming system according to an embodiment;

FIG. 2 is a block diagram of the image forming system according to the embodiment;

FIG. 3 illustrates schematic sectional views showing a recording medium processed by a laminating device;

FIG. 4 illustrates display examples of a display part included in the image forming system according to the embodiment;

FIG. 5 illustrates an example of a database held by a storage section of the image forming system according to the embodiment;

FIG. 6 is a flowchart illustrating a post-processing method according to the embodiment;

FIG. 7 illustrates display by the display part based on a post-processing program according to the embodiment;

FIG. 8 is a flowchart illustrating a modification example of the post-processing method according to the embodiment; and

FIG. 9 illustrates display by the display part based on the post-processing program according to the embodiment.

### DETAILED DESCRIPTION

Hereinafter, one or more embodiments of a post-processing system, an image forming system, and a post-processing method to which the present invention is applied will be described in detail with reference to the drawings. However, the scope of the invention is not limited to the disclosed embodiments.

### <<Image Forming System>>

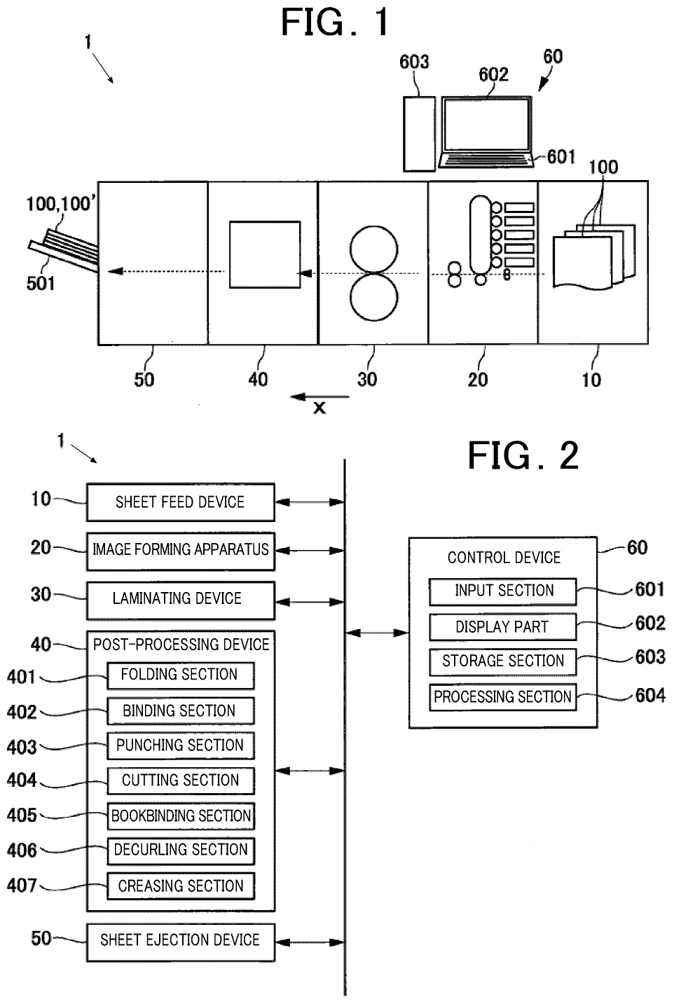

FIG. 1 is a schematic diagram illustrating a configuration of an image forming system 1 according to an embodiment. FIG. 2 is a block diagram of the image forming system 1 according to the embodiment. The image forming system 1 shown in FIG. 1 and FIG. 2 includes a post-processing system for post-processing recording media after image formation. The image forming system 1 includes a sheet feed device 10, an image forming apparatus 20, a laminating device 30, a post-processing device 40 and a sheet ejection device 50 disposed in this order along a conveyance direction x of recording media 100, and a control device 60. These devices/apparatuses are as follows.

### <Sheet Feed Device 10>

The sheet feed device 10 can accommodate a large amount of sheet-shaped recording media 100, and sequentially supplies the accommodated recording media 100 to the image forming apparatus 20. The sheet feed device 10 can accommodate different types of recording media 100 and feeds a recording medium 100 of a type selected on the basis of an instruction from the control device 60 described later to the image forming apparatus 20.

### <Image Forming Apparatus 20>

The image forming apparatus 20 forms an image on the recording medium 100 supplied from the sheet feed device 10, on the basis of an instruction from the control device 60 described later. In this embodiment, the image forming apparatus 20 is, as an example, an electrophotographic image forming apparatus that forms a toner image, but not limited thereto, and may be an apparatus employing another method such as the inkjet method.

### <Laminating Device 30>

The laminating device 30 constitutes part of a post-processing system. The laminating device 30 performs lamination of boning a laminate film(s) to the recording medium 100 on which the image has been formed in the image forming apparatus 20.

The laminating device 30 bonds a laminate film(s) to both sides or one side of the recording medium 100, on the basis of an instruction from the control device 60 described later. The laminating device 30 sends a processed medium 100 that is the laminated recording medium 100 to the post-processing device 40. On the basis of an instruction from the control device 60, the laminating device 30 may send the recording medium 100 to the post-processing device 40 without bonding a laminate film to the recording medium 100.

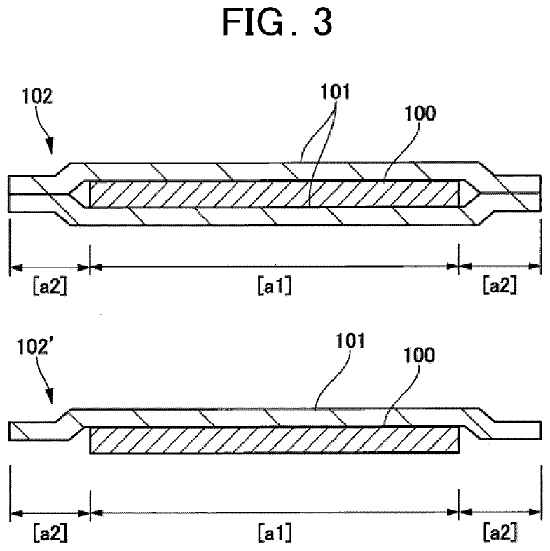

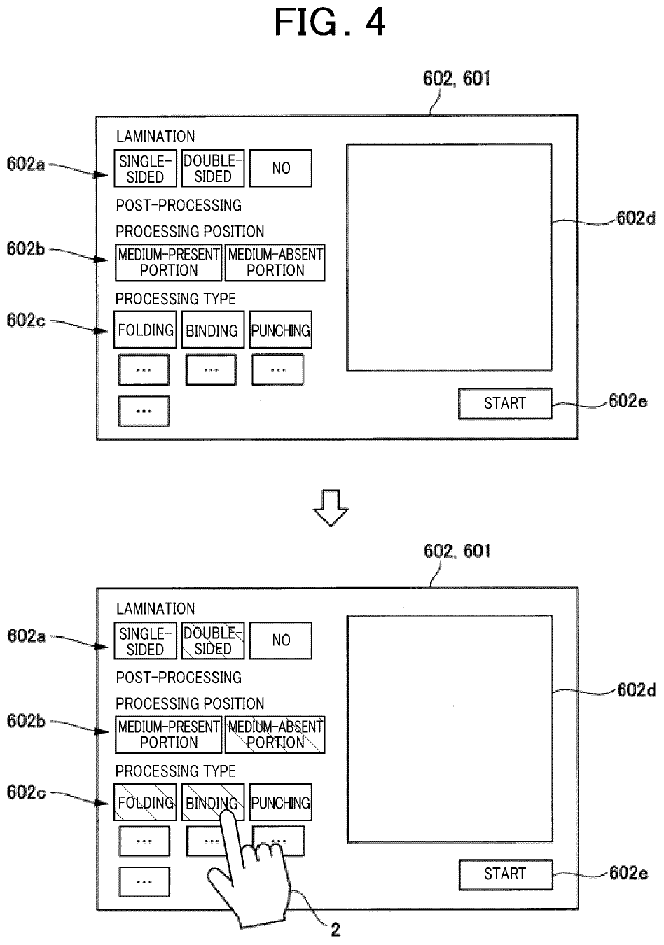

FIG. 3 illustrates schematic sectional views showing the recording medium 100 laminated by the laminating device 30 (illustrated in FIG. 1 and FIG. 2). The laminating device 30 bonds laminate films 101 to both sides of the recording medium 100 to form a processed medium 102, on the basis of an instruction from the control device 60. In this case, edges of the two laminate films 101 bonded are bonded to each other. Alternatively, the laminating device 30 bonds a laminate film 101 to one side of the recording medium 100 to form a processed medium 102′, on the basis of an instruction from the control device 60. In this case, the laminate film 101 is, for example, one size larger than the recording medium 100, and the edge of the laminate film 101 is arranged outside the recording medium 100. Each of these processed media 102 and 102′ has, as areas in plan view, a medium-present portion [a1] where the recording medium 100 and the laminate film(s) 101 are laid on top of one another and medium-absent portions [a2] where only the laminate film(s) 101 is present. In some cases, the laminating device 30 places the outer peripheral edge of the recording medium 100 outside the laminate film(s) 101, on the basis of an instruction from the control device 60.

### <Post-Processing Device 40>

Returning to FIG. 1, the post-processing device 40 constitutes part of the post-processing system. The post-processing device 40 performs post-processing on the recording medium 100 sent from the laminating device 30. The recording medium 100 sent from the laminating device 30 is either a laminated recording medium 100 (i.e., processed medium 102 or 102′) or a not-laminated recording medium 100. When a recording medium 100 is not laminated by the laminating device 30, the recording medium 100 is conveyed to the post-processing device 40 without being laminated, for example, by being conveyed by bypassing a laminating section in the laminating device 30.

The post-processing device 40 includes multiple types of post-processing sections, and performs a type(s) of post-processing selected on the basis of an instruction from the control device 60 described later. The post-processing sections included in the post-processing device 40 are, for example, a folding section 401 (folder), a binding section 402 (binder), a punching section 403 (puncher), a cutting section 404 (cutter), a bookbinding section 405, a decurling section 406, and a creasing section 407. Of these post-processing sections, the folding section 401, the binding section 402, and the punching section 403 are post-processing sections that perform post-processing on stacked recording media 100 at once. The folding section 401 forms a fold of a predetermined shape in the stacked recording media 100. The binding section 402 binds the stacked recording media 100 with a stapler or the like. The punching section 403 punches holes in the stacked recording media 100. The other post-processing sections are post-processing sections that perform post-processing on a recording medium 100 each time it is sent from the laminating device 30. The cutting section 404 cuts recording media 100 one by one.

The post-processing device 40 includes, in addition to the above-described post-processing sections, an inspection section that inspects post-processed recording media 100, and a large-capacity stacking section where post-processed recording media 100 are placed and held, for example.

### <Sheet Ejection Device 50>

The sheet ejection device 50 sequentially ejects the recording media 100 conveyed from the post-processing device 40 to a tray 501. If there are two or more trays, the recording media 100 are distributed among and ejected to the trays. The recording media 100 to be ejected from the sheet ejection device 50 are each ejected as a product 100′ which has been subjected to at least one of lamination and post-processing or has not been subjected to either of lamination and post-processing.

### <Control Device 60>

The control device 60 constitutes part of the post-processing system and controls operation of each device/apparatus included in the image forming system 1. The control device 60 includes an input section 601 (inputter) and a display part 602 (display) as a user interface, and also includes a storage section 603 (storage) and a processing section 604 (hardware processor) as a calculator. The calculator is hardware which is used as a computer. The calculator includes a central processing unit (CPU), a read only memory (ROM), and a random access memory (RAM). The calculator further includes a nonvolatile storage and a network interface.

### [Input Section 601 and Display Part 602]

The input section 601 and the display part 602 are parts for a user to set operation of each device/apparatus included in the image forming system 1. The display part 602 is also a notification section for notifying the user of information on the image forming system 1. The display part 602 may be a touch screen which also serves as the input section 601.

FIG. 4 illustrates display examples of the display part 602 of the image forming system according to the embodiment, and illustrates a setting screen for lamination that is performed by the laminating device 30 and post-processing that is performed by the post-processing device 40 (see FIG. 1). The display part 602 is a touch screen which also serves as the input section 601, and displays a lamination setting part 602a, a processing position setting part 602b, a processing type setting part 602c, a notification part 602d, and a start button 602e.

The lamination setting part 602a is a part for setting lamination to be performed on a recording medium(s) 100 (see FIG. 3), and the user can select any one of “Single-sided”, “Double-sided”, and “NO” (no lamination).

The processing position setting part 602b is a part for setting the position of post-processing to be performed on the recording medium 100 (see FIG. 3), and the user can select one of a “medium-present portion” and a “medium-absent portion”. As illustrated in FIG. 3, the medium-present portion [a1] is a part where a recording medium 100 and a laminate film(s) 101 are laid on top of one another, and each medium-absent portion [a2] is a part where only the laminate film(s) 101 is present.

The processing type setting part 602c in FIG. 4 is a part for setting a type(s) of post-processing to be performed on the recording medium 100, and the user can select two or more post-processing sections included in the post-processing device 40. On the upper side in FIG. 4, the pre-setting state is illustrated. As illustrated on the lower side in FIG. 4, in the post-setting state, the display part 602 notifies a user 2 of settings, for example, by changing the display color of a processing type(s) selected by the user 2.

The notification part 602d is a part for notifying the user of information on the settings about post-processing. The start button 602e is a part for the user to complete the settings about post-processing.

The display part 602 performs display on the basis of an instruction from the processing section 604 or a reception signal from an external device such as a personal computer connected to the image forming system 1. In addition to the above, the display part 602 also displays a setting screen related to image formation in the image forming apparatus 20, for example.

### [Storage Section 603]

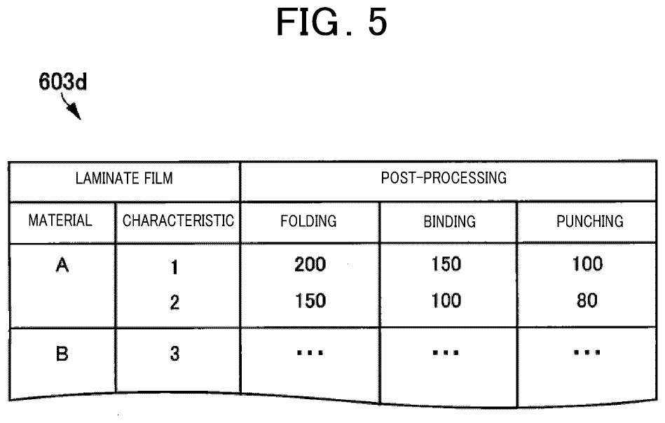

Returning to FIG. 1 and FIG. 2, the storage section 603 is a part that holds information necessary for operating each device/apparatus included in the image forming system 1. FIG. 5 illustrates an example of a database held by the storage section of the image forming system according to the embodiment, and illustrates a database 603d of upper limit numbers of sheets to be post-processed by the post-processing device 40 (see FIG. 1). The upper limit numbers of sheets (i.e., upper limit values) indicated by the database 603d of FIG. 5 is the numbers of recording media 100 that can be post-processed at a time in types of post-processing (folding, binding, punching, etc.) in which recording media 100 are processed at a time in a stacked state.

Into the post-processing device 40 (see FIG. 1) which performs post-processing, recording media 100 laminated by the laminating device 30 are sent. Therefore, the database 603d holds the upper limit number of sheets for each type of laminate film 101 (see FIG. 3). The type of laminate film 101 is the material and characteristics of the laminate film 101. The characteristics are the thickness and stiffness of the laminate film 101, and in FIG. 5, a combination of the thickness and stiffness.

The laminating device 30 bonds a laminating film(s) 101 to one or both sides of a recording medium 100. Post-processing that is performed by the post-processing device 40 is performed on either the medium-present portion [a1] or the medium-absent portion [a2] (see FIG. 3). The database 603d holds, as an example, the upper limit number of sheets for each type of post-processing that is performed on the medium-absent portion [a2] of the one-side-laminated processed media 102′ in which a laminate film 101 is bonded to only one side of the recording medium 100. That is, the database 603d holds the upper limit number of sheets for each type of post-processing that is performed on laminated recording media 100. The database 603d may include the upper limit number of sheets for each type of post-processing that is performed on a not-laminated recording medium(s). In the case of processing on the medium-absent portion [a2], a similar database can be used. The upper limit numbers of sheets held by the storage section 603 are the numbers of sheets set as the maximum values at which no processing failure occurs and occurrence of mechanical malfunction is suppressed in the respective types of post-processing according to a preliminary experiment.

### [Processing Section 604]

Returning to FIG. 1 and FIG. 2, the processing section 604 performs a process(es) for controlling operation of each component of the image forming system in accordance with inputs from the input section 601 or reception signals from an external device such as a personal computer connected to the image forming system 1. The processing section 604 performs a characteristic process(es) for carrying out the post-processing method described later. The procedure for post-processing that is performed by the processing section 604 is a procedure that is performed at the time of execution of a job by the image forming system 1, and is loaded and saved as a post-processing program from the ROM of the processing section 604 or an external device to the RAM.

### <<Post-Processing Method>>

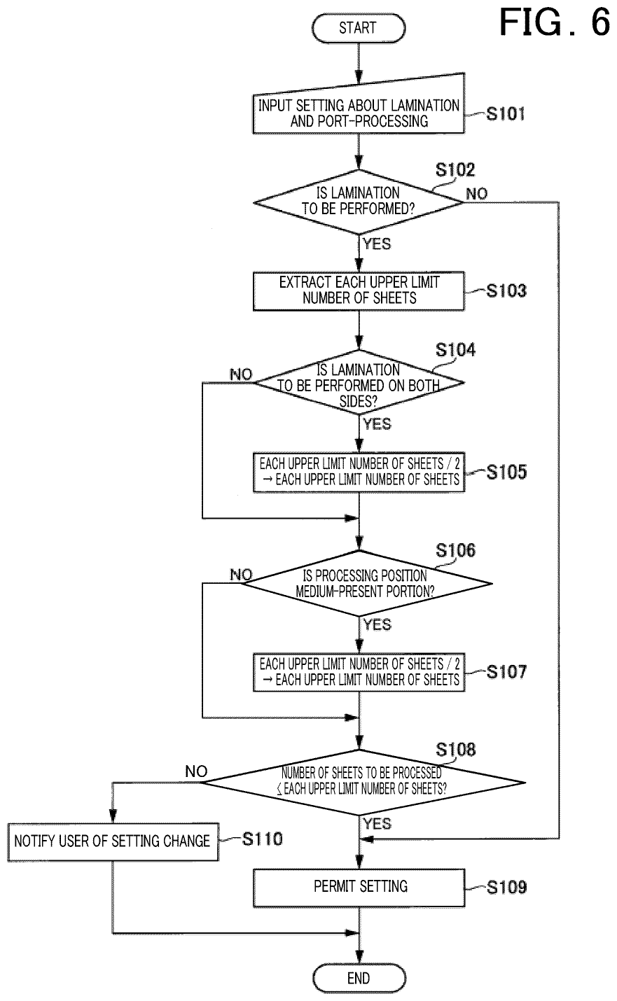

Next, the post-processing method that is performed in the above-described image forming system 1 according to the embodiment will be described. FIG. 6 is a flowchart illustrating the post-processing method according to the embodiment. The post-processing method illustrated by the flowchart of FIG. 6 is a setting procedure for lamination that is performed by the laminating device 30 and post-processing that is performed by the post-processing device 40, which are illustrated in FIG. 1 and FIG. 2, and is a procedure including lamination as post-processing. The post-processing method is implemented by the CPU constituting the processing section 604 in the image forming system 1 executing a process(es) based on the post-processing program saved in the ROM or the RAM. Hereinafter, the post-processing method of the embodiment will be described along the flowchart of FIG. 6 with reference to FIG. 1 to FIG. 5 and other figures as necessary.

### [Step S101]

In Step S101, the user inputs settings about lamination and post-processing. At the time, in setting a job including image formation and post-processing by the image forming system 1, the processing section 604 causes the display part 602 to display a setting screen for post-processing. The setting screen for post-processing is the setting screen described with reference to FIG. 4. The user 2 selects and inputs settings about lamination that is performed by the laminating device 30 and for post-processing that is performed by the post-processing device 40 on the setting screen.

### [Step S102]

In Step S102, the processing section 604 determines whether lamination has been selected in Step S101 to be performed in the settings about lamination. If “Single-sided” or “Double-sided” is selected at the lamination setting part 602a of the setting screen shown in FIG. 4, the processing section 604 determines that lamination is to be performed (YES) and proceeds to Step S103. If “No” (no lamination) is selected at the lamination setting part 602a of the setting screen, the processing section 604 determines that lamination is not to be performed (NO) and proceeds to Step S109.

### [Step S103]

In Step S103, if one (or more) of “Folding”, “Binding”, and “Punching” is set as a processing type of post-processing in Step S101, the processing section 604 extracts the upper limit number of sheets for the set processing type from the database 603d (see FIG. 5) of the storage section 603. Assume that the information on the material and characteristics of the laminate film has already been set at the time of setting the laminate film in the laminating device 30 (see FIG. 1). The processing section 604 extracts the upper limit number of sheets for each type of post-processing set in Step S101 from among the upper limit numbers of sheets held in association with the material and characteristics of the set laminate film. As an example, if the material of the laminate film is A, the characteristic(s) thereof is 1, and “Folding” and “Binding” are set as processing types of post-processing in Step S101, the processing section 604 extracts 200 as the upper limit number of sheets for folding and 150 as the upper limit number of sheets for binding.

In Step S101, no processing types such as “Folding”, “Binding”, and “Punching”, which are types of post-processing that are performed on stacked recording media 100 at a time, may not be selected as processing types of post-processing. In this case, the processing section 604 may proceed to Step S109 before Step S103.

### [Step S104]

In Step S104, the processing section 604 determines whether double-sided lamination has been selected in the setting about lamination in Step S101. If “Double-sided” is selected at the lamination setting part 602a of the setting screen shown in FIG. 4, the processing section 604 determines that lamination is performed on both sides (YES) and proceeds to Step S105. If “Single-sided” is selected at the lamination setting part 602a of the setting screen, the processing section 604 determines that lamination is not performed on both sides (NO) and proceeds to Step S106.

### [Step S105]

In Step S105, the processing section 604 performs a process of reducing each upper limit number of sheets extracted in Step S103 by the amount corresponding to two laminate films that are to be laid on a recording medium 100. Therefore, in this step, the processing section 604 performs a process of halving each upper limit number of sheets extracted in Step S103, and sets each number of sheets after the process as each new upper limit number of sheets. In Step S105, the processing section 604 may perform arithmetic processing of multiplying each upper limit number of sheets by a predetermined coefficient A (A=less than 1.0) in place of the arithmetic processing of halving each upper limit number of sheets.

### [Step S106]

In Step S106, the processing section 604 determines whether the processing position in the setting about lamination in Step S101 is the medium-present portion [a1] (see FIG. 3). If the “medium-present portion” is selected at the processing position setting part 602b of the setting screen shown in FIG. 4, the processing section 604 determines that the processing position is the medium-present portion (YES) and proceeds to Step S107. If the “medium-absent portion” is selected at the processing position setting part 602b of the setting screen, the processing section 604 determines that the processing position is not the medium-present portion (NO) and proceeds to Step S108.

### [Step S107]

In Step S107, the processing section 604 performs a process of reducing each upper limit number of sheets extracted in Step S103 or each new upper limit number of sheets set in Step S105 by the amount corresponding to recording media to be stacked. In this step, as an example, the processing section 604 performs a process of halving each upper limit sheet number, and sets each number of sheets after the process as each new upper limit number of sheets. In Step S107, the processing section 604 performs arithmetic processing of multiplying each upper limit number of sheets by a predetermined coefficient B (B=less than 1.0) for the type of recording media in place of the arithmetic processing of halving each upper limit number of sheets. Thus, it is possible to calculate accurate upper limit numbers of sheets.

### [Step S108]

In Step S108, the processing section 604 determines whether the number of sheets (i.e., the number of recording media 100) to be processed is equal to or less than each upper limit number of sheets. The number of sheets to be processed is the number of sheets on which post-processing is performed at once for each copy in execution of a job by the image forming system 1. Examples thereof include the number of pages of a document per copy input in a job, and the number of pages set by the user as a document of one copy.

The processing section 604 compares the number of sheets to be processed with each upper limit number of sheets obtained for each processing type of post-processing. If, as a result of comparison, all of the upper limit numbers of sheets are equal to or less than the number of sheets to be processed, the processing section 604 determines that the number of sheets to be processed is equal to or less than each upper limit number of sheets (YES) and proceeds to Step S109, and if not, proceeds to Step S110.

### [Step S109]

In Step S109, the processing section 604 permits the setting input in Step S101. Thus, the processing section 604 activates the start button 602e (see FIG. 4) on the display part 602, and enables execution of a job by the image forming system 1 by the user 2 selecting the start button 602e.

If the processing section 604 determines in Step S102 that lamination is not to be performed (NO) and proceeds to this Step S109, in execution of a job, the post-processing device 40 performs post-processing on a not-laminated recording medium(s) 100. In this case, the post-processing device 40 performs post-processing on the number of not-laminated recording media 100 that is the number of sheets to be processed that does not exceed each upper limit number of sheets originally set.

### [Step S110]

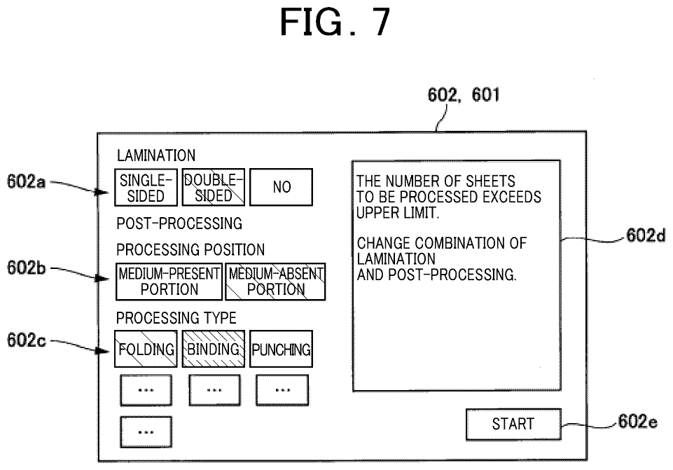

In Step S110, the processing section 604 causes the display part 602 to display a setting change notification on the notification part 602d. FIG. 7 illustrates display by the display part 602 based on the post-processing program according to the embodiment. As illustrated in FIG. 7, the processing section 604 causes the display part 602 to display, on the notification part 602d, a message that the number of sheets to be processed exceeds the upper limit number(s) of sheets and also to display change in the settings about lamination and post-processing. The processing type(s) for which the number of sheets to be processed exceeds the upper limit number of sheets is made to blink, the display color thereof is changed, or the like, to notify the user of the processing type(s) for which the upper limit number of sheets is exceeded.

After Step S110, the processing section 604 allows the settings about lamination and post-processing to be changed on the display part 602 and ends the process.

### Advantageous Effects of Embodiment

According to the above-described embodiment, the upper limit number of sheets to be processed in each post-processing section of the type that processes stacked recording medium 100 at once is set in accordance with the setting about lamination. Therefore, no excessive load is applied to these post-processing sections during processing, and as a result, it is possible to prevent occurrence of processing failure during post-processing and malfunction of each post-processing section of the post-processing device 40.

Furthermore, the storage section 603 holds the upper limit number of sheets for each type of post-processing that is performed on the medium-absent portion [a2] of the processed media 102′ (see FIG. 3) in each of which a laminate film 101 is bonded to only one side of the recording medium 100. However, the storage section 603 may hold the upper limit number of sheets for each type of post-processing that is performed on the medium-absent portion [a2] of the processed media 102 in each of which laminate films 101 are bonded to both sides of the recording medium 100. In this case, in Step S104 of FIG. 6, the processing section 604 determines whether lamination is on one side, and in Step S105, performs a process of doubling each upper limit number of sheets extracted from the storage section 603.

### Modification Example of Post-processing Method

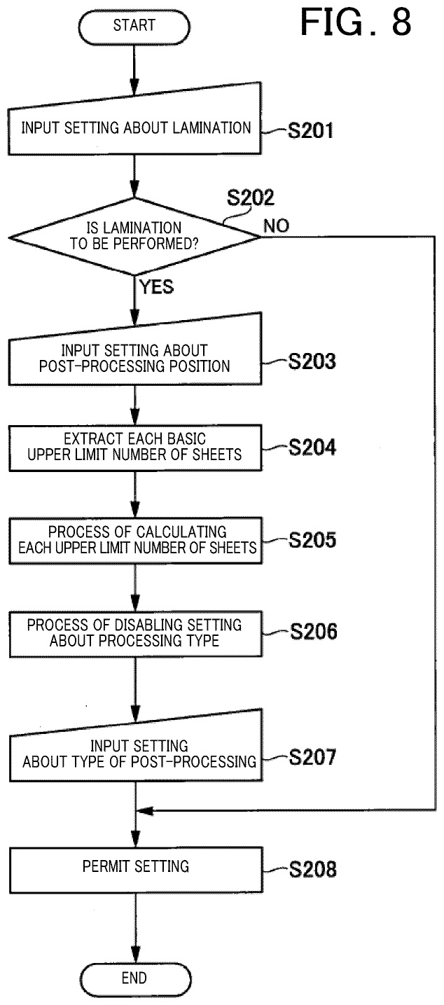

FIG. 8 is a flowchart illustrating a modification example of the post-processing method according to the embodiment, and the post-processing method is performed by the processing section 604 in the image forming system 1 illustrated in FIG. 2. Hereinafter, the post-processing method of the modification example will be described along the flowchart of FIG. 8 with reference to FIG. 1 to FIG. 5 and other figures as necessary.

### [Step S201]

In Step S201, the user inputs setting about lamination. At the time, in setting a job of image formation by the image forming system 1, the processing section 604 causes the display part 602 to display a setting screen for post-processing. The setting screen for lamination may be, for example, the setting screen described with reference to FIG. 4. The user 2 selects and inputs the setting about lamination that is performed by the laminating device 30 (see FIG. 1) on the setting screen.

### [Step S202]

In Step S202, the processing section 604 determines whether lamination has been selected in Step S201 to be performed. This determination is made in the same manner as in Step S102, and if the processing section 604 determines that lamination has been selected to be performed (YES), the processing section 604 proceeds to Step S203, whereas if the processing section determines that lamination has not been selected not to be performed (NO), the processing section 604 proceeds to Step S208.

### [Step S203]

In Step S203, subsequent to the setting about lamination in Step S201, the user inputs setting about the processing position of post-processing. The setting screen for post-processing may be the setting screen described with reference to FIG. 4. The user 2 selects the “medium-present portion” or the “medium-absent portion” as the processing position of post-processing at the processing position setting part 602b of the setting screen.

### [Step S204]

In Step S204, the processing section 604 extracts the upper limit number of sheets for each processing type of post-processing from the database 603d (see FIG. 5) of the storage section 603. Assume that the information on the material and characteristics of the laminate film has already been set at the time of setting the laminate film in the laminating device 30 (see FIG. 1). The processing section 604 extracts the upper limit number of sheets for all processing types held in association with the material and characteristics of the set laminate film. As an example, if the material of the laminate film is A, the characteristic(s) thereof is 1, the processing section 604 extracts 200 as the upper limit number of sheets for folding, 150 as the upper limit number of sheets for binding, and 100 as the upper limit number of sheets for punching. This Step S204 is performed at the time when it is determined in Step S202 that lamination is to be performed (YES), and therefore may be performed between Step S202 and Step S203.

### [Step S205]

In Step S205, the processing section 604 performs a process of calculating each upper limit number of sheets. At the time, the processing section 604 processes, on the basis of the settings in Step S201 and Step S203, the upper limit numbers of sheets extracted in Step S204 to calculate new upper limits number of sheets. The calculation of new upper limit values is performed by the procedure of Step S104 to Step S107 described above. As a result, new upper limit numbers of sheets for folding, binding, and punching are calculated. If lamination is on one side and the processing position of post-processing is the medium-absent portion [a2], the upper limit numbers of sheets extracted in Step S204 are the upper limit numbers of sheets as they are.

### [Step S206]

In Step S206, the processing section 604 performs a process of disabling setting about a processing type(s), on the basis of each upper limit number of sheets calculated in Step S205. At the time, the processing section 604 determines whether the number of sheets to be processed is equal to or less than each upper limit number of sheets calculated in Step S205. This number of sheets to be processed is the same as the number of sheets to be processed described for Step S108.

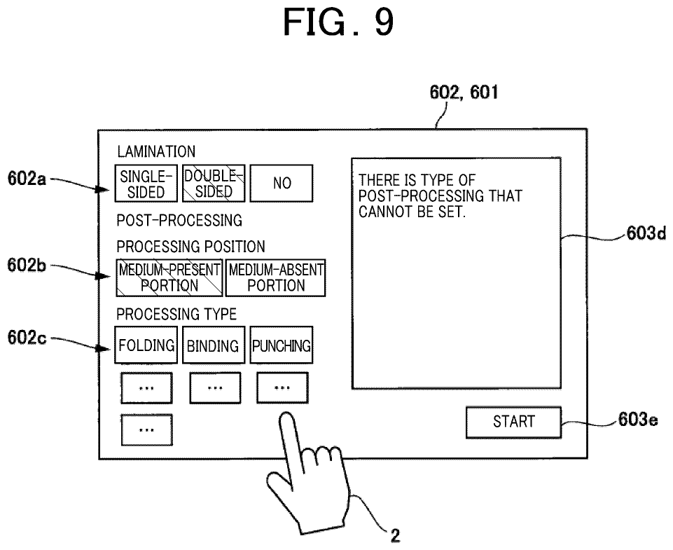

The processing section 604 compares the number of sheets to be processed with each of the upper limit numbers of sheets for folding, binding, and punching calculated in Step S205. Then, on the display part 602, each processing type whose upper limit number of sheets is less than the number of sheets to be processed is, for example, displayed in a display color different from that of the other processing type(s) or made to blink, to disable setting about the processing type. FIG. 9 illustrates display by the display part 602 based on the post-processing program according to the embodiment. As shown in FIG. 9, for example, if the upper limit number of sheets for punching is less than the number of sheets to be processed, the processing section 604 changes display of “Punching” at the processing type setting part 602c of the display part 602 to disable selection thereof. If the upper limit numbers of sheets for all of the processing types calculated in Step S205 are each equal to or more than the number of sheets to be processed, the processing section 604 may permit settings about all of the processing types at the processing type setting part 602c of the display part 602.

### [Step S207]

In Step S207, the user inputs the setting about a processing type(s) of post-processing on the setting screen of the display part 602 illustrated in FIG. 9. The user 2 selects and inputs the setting about post-processing that is performed by the post-processing device 40 (see FIG. 1) on the setting screen.

### [Step S208]

In Step S208, the processing section 604 permits the setting input in Step S201, Step S203, and Step S207. Thus, the processing section 604 activates the start button 602e (see FIG. 9) on the display part 602, and enables execution of an image formation job by the image forming system 1 by the user 2 selecting the start button 602e.

### Advantageous Effects of Modification Example

According to the above-described modification example too, the upper limit number of sheets to be processed in each post-processing section of the type that processes stacked recording medium 100 at once is set in accordance with the setting about lamination. Therefore, as with the embodiment, it is possible to prevent occurrence of processing failure during post-processing by the post-processing device 40 and malfunction of each post-processing section of the post-processing device 40.

In the above-described embodiment, in accordance with the set number of sheets in the setting about lamination and the upper limit number of sheets for a type(s) of post-processing, one or more of the types of post-processing are restricted not to be selected, but in the setting about lamination, selection of one or more of the types of post-processing may be disabled regardless of the number of sheets to be processed. For example, depending on the type (material, thickness, etc.) of laminate film and/or the lamination side(s) (one side or both sides), a sheet and a laminate film(s) may be separated from one another by folding. In such a case, selection of folding (combination of lamination and folding) in the setting about lamination may be disabled regardless of the number of sheets to be processed.

Although embodiments of the present invention have been described and illustrated in detail, the disclosed embodiments are made for purposes of illustration and example only and not limitation. The scope of the present invention should be interpreted by terms of the appended claims.

What is claimed is:

1. A post-processing system comprising:
a laminating device that performs lamination on a recording medium;
a post-processing device that is disposed on a downstream side of the laminating device in a conveyance direction of the recording medium and performs post-processing on the recording medium; and
a control device that controls, in accordance with the lamination by the laminating device, the post-processing that is performed by the post-processing device on the recording medium.

2. The post-processing system according to claim 1, wherein the control device controls the post-processing based on at least one of information on whether the lamination on the recording medium by the laminating device is present or information on an area of the recording medium subjected to the lamination, the area being covered with a laminate film.

3. The post-processing system according to claim 1, wherein the control device controls the post-processing in accordance with a type of a laminate film used in the lamination.

4. The post-processing system according to claim 3, wherein the type of the laminate film is at least one of a material, a thickness, or a stiffness.

5. The post-processing system according to claim 1,
wherein the post-processing device includes post-processing sections different from one another, and
wherein the control device controls, in accordance with the lamination, the post-processing that is performed by at least one of a folder, a binder, a puncher, or a cutter among the post-processing sections included in the post-processing device.

6. The post-processing system according to claim 1, wherein as the control that the control device performs in accordance with the lamination, the control device limits a number of recording media on which the post-processing device is capable of performing the post-processing at once to an upper limit value or less in accordance with the lamination.

7. The post-processing system according to claim 6, wherein the control device prohibits the post-processing device from performing the post-processing in response to a number of recording media to be processed set with respect to the post-processing device exceeding the upper limit value.

8. The post-processing system according to claim 6, wherein the control device sets the upper limit value in accordance with whether an area of the recording medium subjected to the lamination, the area being covered with a laminate film, is present at one side of the recording medium or at both sides of the recording medium.

9. The post-processing system according to claim 6, wherein the control device sets the upper limit value in accordance with a processing position of the post-processing to be performed on the recording medium subjected to the lamination.

10. The post-processing system according to claim 6, wherein the control device sets the upper limit value in accordance with a type of the recording medium.

11. The post-processing system according to claim 6, wherein the control device includes:
an inputter with which settings about the lamination and the post-processing are input;
a storage that holds the upper limit value for each type of a laminate film used in the lamination; and
a hardware processor that processes the upper limit value held in the storage based on the input of the settings from the inputter, thereby calculating a new upper limit value in accordance with the lamination, and determines whether a number of recording media to be processed set with respect to the post-processing device exceeds the calculated upper limit value.

12. The post-processing system according to claim 11,
wherein the post-processing device includes post-processing sections different from one another, and
wherein the storage holds the upper limit value for each of the post-processing sections, and
wherein the hardware processor performs the determination for each of the post-processing sections.

13. The post-processing system according to claim 11, wherein the control device further includes a display that displays a determination result of the determination performed by the hardware processor.

14. The post-processing system according to claim 13, wherein the display displays the determination result after the input of the settings from the inputter is completed.

15. The post-processing system according to claim 13, wherein the display displays the determination result at a point of time when the hardware processor determines that the number of recording media to be processed exceeds the calculated upper limit value.

16. The post-processing system according to claim 13, wherein the display displays, among the settings input from the inputter, a setting that causes the upper limit value to be exceeded by the number of recording media to be processed.

17. The post-processing system according to claim 1, wherein the control device restricts selection of the post-processing in accordance with a setting about the lamination.

18. The post-processing system according to claim 1, wherein the control device restricts a selectable type of the post-processing in accordance with a setting about the lamination.

19. An image forming system comprising:
the post-processing system according to claim 1; and
an image forming apparatus that is disposed on an upstream side of the laminating device in the conveyance direction of the recording medium and forms an image on the recording medium.

20. A post-processing method that is performed by a post-processing system including: a laminating device that performs lamination on a recording medium; and a post-processing device that is disposed on a downstream side of the laminating device in a conveyance direction of the recording medium and performs post-processing on the recording medium, the post-processing method comprising:
with a control device, controlling, in accordance with the lamination by the laminating device, the post-processing that is performed by the post-processing device on the recording medium.
